(19) United States
(12) Patent Application Publication
(10) Pub. No.: US 2001/0014847 A1
(43) Pub. Date: Aug. 16, 2001

(54) Apparatus and method monitoring traffic

(76) Inventor: Roger Henry Keenan, Linslade (GB)

Correspondence Address: RATNER AND PRESTIA, One Westlakes, Berwyn, Suite 301, P.O. Box 980, Valley Forge, PA, 19482-0980, US

(21) Appl. No.: 09/756,339

(22) Filed: Jan. 8, 2001

(30) Foreign Application Priority Data
Jan. 27, 2000 (GB) 0001843.2
Sep. 29, 2000 (GB) 0023837.8

(51) Int. Cl. G06G 7/76

(52) U.S. Cl. 701/117; 701/200

(57) ABSTRACT

An apparatus and method for monitoring traffic comprises a plurality of vehicles fitted with units. Each unit comprises a CPU, a timer and a GPS device. Whenever a vehicle passes a waypoint determined by the GPS device, the CPU notes the time supplied by the timer. When the vehicle passes the next waypoint determined by the GPS device, the CPU notes the time again. The CPU substracts the two times to derive the actual journey time for the link between the two waypoints, and this is compared against a stored link-time for the link. If the actual journey time is greater by a preset amount than the stored link-time, then the unit transmits the relevant information to a control computer by way of a communication device. In addition to notifying the control computer when the vehicle has exceeded a standard time for the link between the waypoints, the unit can monitor the progress of the vehicle along the link by monitoring its progress along sublinks using a technique known as “micro-pointing”.

This invention relates to an apparatus and a method for monitoring traffic and to a method of selecting commencement and termination points for transit time measurements on a road network. In particular this invention relates to an apparatus and a method for monitoring traffic using floating car data.

The use of floating car data to monitor traffic is known. The method involves fitting a large number of vehicles with equipment which can measure the speed, position and travel direction of the vehicle and which can transmit this information to a central station. A computer at the central station then uses this received data to build a dynamic picture of the traffic on the road network in the region in which the vehicles are operating. The method requires a large number of vehicles to be fitted with the equipment and to be in motion on the road network.

The central computer requires a large amount of computing power, and there is a high communication cost in transmitting the floating car data from the vehicles to the central station.

EP 0 880 120 A2 (Daimler-Benz AG) describes a floating car data method in which the amount of transmitted data is reduced. In this method an automatic position detection is carried out in the sample vehicle at predetermined time intervals. The vehicle is provided with an on-board computer which stores information about the road network and the expected journey duration for sub-sections of the road network. After each position detection is carried out, the on-board computer records the subsection travelled since the previous position detection and calculates the actual journey duration. Then, using the stored expected journey duration information, the on-board computer calculates either the expected position for the actual journey duration or the expected journey duration for the actual position, compares the expected position or journey duration with the actual position or journey duration, and transmits data relating to the traffic situation only if the difference is greater than a predetermined threshold.

WO 98/12682 (Detemobil) describes a floating car data method in which the amount of transmitted data is reduced. In this method each vehicle is provided with a decentralised unit which is able to determine position and to transmit and receive data by mobile communication. A central unit at a central station is allocated to several decentralised units. Each decentralised unit contains a database of road network information which is a subset of the database of road network information contained by the central unit. The central unit activates programs stored in the decentralised unit through control signals transmitted from the central station to the vehicle. The reporting of traffic data from the decentralised unit to the central unit is controlled by the programs according to predetermined criteria.

The existing methods utilise a road network model which has a number of predetermined subsections or detection points. Motion of the vehicles is measured with respect to these predetermined subsections or detection points. If greater detail is required about the motion of the vehicles, then a road network model with a greater density of subsections or points must be used, which greatly increases the communication and processing requirements of the system.

It is an object of the present invention to provide an apparatus and a method for monitoring traffic which enables more efficient monitoring in greater detail of a particular part of the road network without requiring increased communication and processing capacity.

According to a first aspect of the present invention, there is provided a method of selecting commencement and termination points on a road network for transit time measurements on a road network, wherein at least one point for at least one of the roads of the network is selected without that selection being determined by any other road of the network. The commencement and termination points are physical, geographical locations on the road network.

Preferably the road network comprises a plurality of node points interconnected by a plurality of route segments, each node point having at least three route segments associated with it. Preferably the at least one point is not coincident with any one of said plurality of node points.

Preferably the selection of the commencement and termination points takes place at a control centre. Preferably data defining the positions of the commencement and termination points is communicated from the control centre to a plurality of vehicles equipped to measure the transit time between the commencement and termination points and to communicate data relating to the measured transit time back to the control centre.

Preferably data defining the predicted transit time between the commencement and termination points is communicated from the control centre to the plurality of vehicles. Preferably each vehicle is equipped to compare the measured transit time with the predicted transit time and to communicate data relating to the measured transit time back to the control centre only if the difference between the measured transit time and the predicted transit time exceeds a threshold value. The parameters defining the threshold value may also be communicated from the control centre to the plurality of vehicles.

According to a second aspect of the present invention, there is provided an apparatus for monitoring traffic, including a memory in which is recorded a programme for selecting commencement and termination points for transit time measurements on a road network, wherein the programme selects at least one point of said commencement and termination points for at least one of the roads of the network without that selection being determined by any other road of the network. The commencement and termination points are physical, geographical locations on the road network.

Preferably the road network comprises a plurality of node points interconnected by a plurality of route segments, each node point having at least three route segments associated with it. Preferably the at least one point is not coincident with any one of said plurality of node points.

Preferably the memory is in a control centre. Preferably the control centre includes communication means adapted to transmit data defining the positions of the commencement and termination points from the control centre to a plurality of vehicles equipped to measure the transit time between the commencement and termination points. Preferably the communication means is adapted to receive data relating to the measured transit time from the vehicles.

Preferably there is recorded in the memory a programme for defining the predicted transit time between the commencement and termination points, wherein the programme calculates a predicted transit time dependent on one or more of the location of the points, the monitored traffic conditions and the time of day. Preferably the communication means is adapted to transmit data relating to the predicted transit time.

Owing to these aspects of the invention, it is possible to split up a road network for calculating transit times on that network without the splitting being predetermined by the make-up of the network, thereby giving complete flexibility in the choice of the location of the commencement and the termination points.

According to a third aspect of the present invention, there is provided a method of monitoring traffic comprising:

selecting a commencement point and a termination point,

communicating positional data for the commencement point and termination point to each of a plurality of vehicles,

at each of the plurality of vehicles monitoring when the vehicle passes from the commencement point to the termination point and calculating the transit time taken for the vehicle to travel between the two points,

comparing the transit time taken with a standard transit time for travel between the two points, and

communicating with a control centre if said transit time taken exceeds the said standard transit time by more than a preset amount.

The standard transit time and the preset amount may be selected at the control centre and communicated to each of the plurality of vehicles. The standard transit time and the preset amount may vary according to one or more of the location of the points, the monitored traffic conditions and the time of day.

According to a fourth aspect of the present invention, there is provided apparatus for monitoring traffic comprising a plurality of arrangements each carried by respective vehicles, each arrangement comprising calculating means for calculating the transit time taken to travel between two points and for comparing the transit time taken with a standard transit time for travel between the two points and communicating means communicating with a control centre if said transit time taken exceeds the said standard transit time by more than a preset amount.

Preferably said communicating means is adapted to receive information from the control centre defining the position of at least one of the two points. Preferably the two points are a commencement point and a termination point respectively.

Owing to these aspects of the invention, it is possible to provide an in-vehicle traffic monitoring system in which the amount of data that needs to be transmitted to a control centre is minimised.

According to a fifth aspect of the present invention, there is provided a method of monitoring traffic comprising:

establishing along a road first and second points at respective ends of a route segment along which a vehicle is to travel, the route segment being subdivided into a number of links,

at the vehicle, calculating in turn the transit times taken for the vehicle to travel along respective links of the route segment,

in turn comparing the transit times taken with expected transit times for the respective links, and

communicating with a control centre if and when any of the transit times taken exceeds the corresponding expected transit time by a predetermined threshold.

Preferably each link extends from a commencement point to a termination point. Preferably the control centre transmits to the vehicle information defining the position of at least one of the said commencement point and termination point.

According to a sixth aspect of the present invention, there is provided apparatus for monitoring traffic comprising:

establishing means arranged to establish along a road first and second points at respective ends of a route segment along which a vehicle is to travel, the route segment being subdivided into a number of links, and

an arrangement to be carried by the vehicle and comprising calculating means which serves to calculate in turn the transit times taken for the vehicle to travel along the said links, comparing means which serves to compare in turn the transit times taken with expected transit times for the respective links, and communicating means which serve to communicate with a control centre if and when any of said transit times taken significantly exceeds to corresponding expected transit time.

Preferably each link extends from a commencement point to a termination point. Preferably said communicating means is adapted to receive information from the control centre defining the position of at least one of the said commencement point and termination point.

Owing to these aspects of the invention, a relatively fast notification of a sudden incident, such as a road accident, can be obtained.

In order that the invention may be clearly and completely disclosed, reference will now be made, by way of example, to the accompanying drawing, in which:

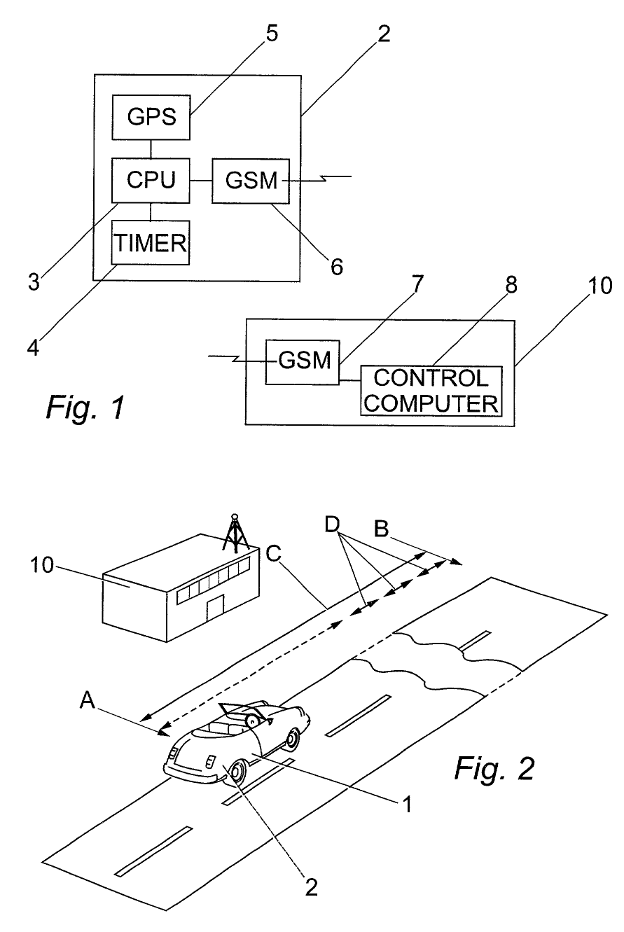

FIG. 1 is a diagram of parts of a traffic monitoring system,

FIG. 2 is a diagrammatic perspective view of the system, and

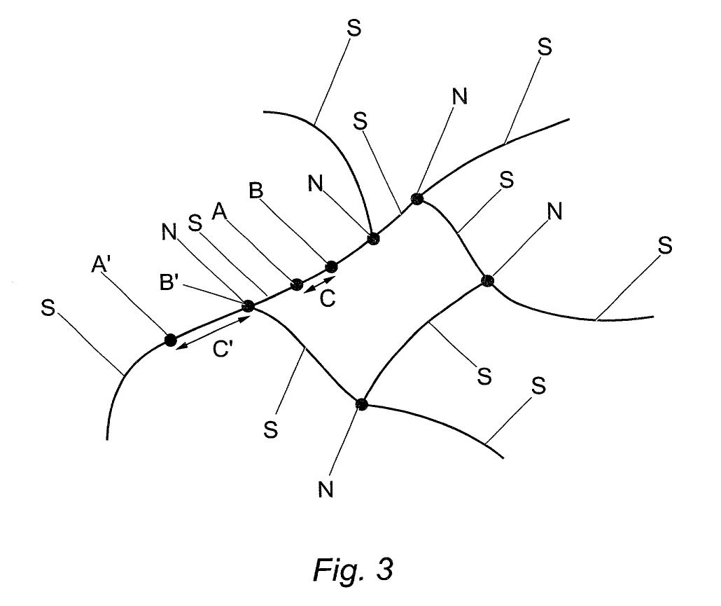

FIG. 3 is a schematic view of a road network.

Referring to the drawing, a vehicle 1 is fitted with an arrangement in the form of a unit 2 that includes a central processing unit (CPU) 3. The CPU 3 includes a memory store. The CPU 3 is connected to an accurate time-measuring device 4, for example a crystal-controlled clock. The CPU 3 is also connected to a Global Positioning System (GPS) device 5 and to a two-way communication device 6, for example a GSM cellular telephone. Such units are known and the data transmitted by such a unit is referred to as floating car data. Instead of the GPS device other positioning systems may be used, for example triangulation using mobile telephony.

The traffic monitoring system comprises a plurality of motor vehicles (including the vehicle 1) fitted with respective units 2, each unit 2 being capable of bi-directional communication, via the communication device 6, and a central two-way communication device 7, for example a GSM apparatus, with a central control computer 8 at a control centre 10. The system can monitor road traffic congestion in real time.

The memory of each unit 2 is loaded with geographic locations of specific points on roads, which are called “waypoints” for the purpose of this application. A waypoint needs no association with anything physical other than being on a road. For example, a waypoint does not need to be associated with a specific location such as a road junction or a crossroads, nor with a detector at a specific location, such as a bridge, along the road. There are no restrictions on the number of waypoints which may exist or their locations on the road. Each waypoint is a known distance from the next waypoint along the road, and the geographic distances between them is called a “link”. There are usually, but not necessarily, two links between two waypoints, one for each direction of travel. The memory of each unit 2 is also loaded with estimated journey times along the links. These estimated journey times are called “link-times”. There may be several link-times for each link, since the estimated journey time may change during the day, or for other reasons, such as roadworks. In FIG. 2, two waypoints A and B are indicated, separated by a link C.

FIG. 3 shows how the waypoints A and B, separated by link C, do not need to correspond to node points N in the road network. Each of the node points N is associated with three or more road segments S. However if required one or more waypoints may correspond to a node point N, as indicated by link C′ joining waypoints A′ and B′, in which waypoint B′ corresponds to a node point N.

In operation, whenever the vehicle 1 passes a waypoint A as determined by the device 5, the CPU 3 notes the time supplied by the timer 4. When the vehicle 1 passes the next waypoint B as determined by the device 5, the CPU notes the time again. The CPU 3 subtracts the two times to derive the actual journey time for the link C, and this is compared against the stored link-time for the link C. The results are stored in the unit 2 on a rolling basis.

If and when the actual journey time is greater by a preset amount than the stored link-time, then by means of the communication device 6 the unit 2 transmits the relevant information (normally the actual journey time, but optionally other relevant information such as the deviation, position and absolute time) to the control computer 8 as soon as it is possible to do so. The preset amount may be fixed for the particular link, or may be the result of a calculation for example based on deviation above a specific percentage. If the actual journey time is less than the stored link-time, no transmission is made.

The control computer 8 receives deviations from the normal link-times from a plurality of vehicles, and from these calculates traffic flow and congestion, using one of several calculation methods already publicly known. Lower than expected speeds on a road are a reliable indicator of congestion.

Additionally, the unit 2 may upload its entire rolling record of actual journey times to the computer 8, which may use it to refine the accuracy of the link-times held in the CPU 3, using one of several calculation methods already publicly known.

Additionally, the computer 8 may download new information to the in-vehicle CPU 3, to modify its memory store of waypoints and link-times.

This approach to traffic congestion measurement gives a minimal communication cost, since each vehicle need transmit only one short message at the end of a link where there is congestion.

The use of waypoints removes all need for transit segments to be related to geographic or physical entities other than a road or roads, and is not limited to use with any particular form of navigation. Moreover the use of waypoints allows the resolution of monitoring to be infinitely varied along the length(s) of a road or roads. Waypoints can also be dynamically allocated. The number of waypoints on a particular section of road can vary according to the time of day, the day of the week, and/or the season, as appropriate. This variability of waypoints leads to a high degree of flexibility. More waypoints would be used when traffic is expected to be heavier and so more accurate information is obtained.

The statistical resolution, and hence accuracy, of such a system is dependent on the percentage of vehicles carrying units 2. Whenever the percentage is low, waypoints and link-times are defined preferably for only congested areas of motorway. As the number of equipped vehicles increases, coverage can be extended to all motorways and, ultimately, to any road with a statistically viable sample of vehicles.

In addition to notifying the control centre 10 when the vehicle 1 has exceeded a standard time for the link C between two waypoints A, B, the unit 2 can monitor the progress of the vehicle along the link C by monitoring its progress along sublinks. This technique is given the name “micro-pointing”. For example, if a vehicle has 10 km to travel between two waypoints A, B and it normally takes a link-time of ten minutes to travel this distance, the unit 2 can divide the link C into sublinks D, for example ten sublinks of one minute each. Using the GPS 5 to identify when each one-kilometre sublink D has been completed, the unit 2 notes the time taken for each sublink D. The unit 2 notifies the control centre 10 when the time for a sublink D greatly exceeds the expected amount. In the above example a time of one minute 20 seconds for a sublink would not be perceived as resulting from a problem. However a time of three minutes for a sublink would result in the unit notifying the control centre 10 accordingly. If only one unit 2, corresponding to only one vehicle 1, notifies the control centre 10, this would not necessarily mean that an incident, for example a road accident, affecting traffic flow generally has occurred. However, if a plurality of units 2, say four or more units 2 corresponding to four or more vehicles 1, all notify the control centre 10 at approximately the same time concerning the same sublink D, or possibly the same link C, then this would indicate the presence of an incident. Thus, if a sudden, great change in the sublink time occurs, the unit 2 communicates this immediately to the control centre 10, giving relatively fast notification of an incident compared with the unit 2 notifying the centre 10 either when the link-time has been greatly exceeded or even when the unit reaches the waypoint B at the end of the link C. Again, the degree of micro-pointing, i.e. the number of sublinks D into which any particular link C is divided, can be varied according to the time of day, the day of the week, or the season, as appropriate.

The method and apparatus of the invention offers significant advantages over prior art traffic monitoring systems. It offers a fast response to traffic situations, since it can quickly report changes in sublink times. It offers low communications costs, since data is only transmitted from the vehicle to the central station when a predetermined threshold is reached. Most in-vehicle measurements will not be reported. It can generate meaningful statistical traffic information from a single vehicle, since the progress of a single vehicle over a number of adjacent links or sublinks can be monitored. Road coverage can be dynamically extended as the population of equipped vehicles increases, simply by defining additional waypoints. Reporting parameters can be dynamically varied, giving the most appropriate balance between accuracy, response and communications cost at any time. For example the linktime, and hence the threshold at which reporting takes place, can be varied according to the time of day so that the threshold is higher in the rush hour than outside peak travel times.

It should be noted that each vehicle 1 is equipped identically with the same unit 2. Each unit 2 communicates only with the central station 10, and units 2 do not communicate with each other.

The units 2 do not measure speed against time intervals, nor do they use the measurement of velocity from a GPS receiver. Instead a unit 2 measures the time of travel between a first waypoint and a second waypoint, and compares this measured time with a control, namely the linktime stored in the memory of the unit 2. Waypoints are defined at the central station, not at the unit 2 in the vehicle. The definition of waypoints may be dynamic, so that the central station 10 communicates to each unit updated waypoint definition data according to traffic conditions monitored at the central station, or the definition of waypoints may be preset in each unit, so that updating of waypoint information in the units only takes place at particular times.

Waypoints do not need to correspond to road junctions, although they can do. The only geographic limitation on a waypoint is that it corresponds to a position on a road forming part of the road network to be monitored. A waypoint is a virtual reference point and does not have to correspond to any physical feature.

Modifications and improvements may be made to the embodiments without departing from the scope of the invention. For instance, any positioning system 5 may be used in the unit 2 in each vehicle 1, and the invention is not limited to GPS systems. Indeed the unit 2 does not need a navigation system. Any form of communication system 5 may be used in the unit 2 in each vehicle 1, and the invention is not limited to GSM systems. If the possibility of the control computer 8 defining new waypoints is not required, then the communication system 5 may be a one way system, used only to transmit data from the vehicle 1 to the control centre 10, with all waypoint information being provided in pre-programmed form, for example on a CD-ROM or other readable storage device.

1. A method of selecting commencement and termination points on a road network for transit time measurements on the road network, wherein at least one point for at least one of the roads of the network is selected without that selection being determined by any other road of the network.

2. The method of claim 1, wherein the road network comprises a plurality of node points interconnected by a plurality of route segments, each node point having at least three route segments associated with it.

3. The method of claim 2, wherein the at least one point is not coincident with any one of said plurality of node points.

4. The method of claim 1, wherein the selection of the commencement and termination points takes place at a control centre.

5. The method of claim 4, wherein data defining the positions of the commencement and termination points is communicated from the control centre to a plurality of vehicles equipped to measure the transit time between the commencement and termination points and to communicate data relating to the measured transit time back to the control centre.

6. The method of claim 5, wherein data defining the predicted transit time between the commencement and termination points is communicated from the control centre to the plurality of vehicles.

7. The method of claim 6, wherein each vehicle is equipped to compare the measured transit time with the predicted transit time and to communicate data relating to the measured transit time back to the control centre only if the difference between the measured transit time and the predicted transit time exceeds a threshold value.

8. The method of claim 7, wherein the parameters defining the threshold value may also be communicated from the control centre to the plurality of vehicles.

9. An apparatus for monitoring traffic, including a memory in which is recorded a programme for selecting commencement and termination points on a road network for transit time measurements on the road network, wherein the programme selects at least one point of said commencement and termination points for at least one of the roads of the network without that selection being determined by any other road of the network.

10. The apparatus of claim 9, wherein the road network comprises a plurality of node points interconnected by a plurality of route segments, each node point having at least three route segments associated with it.

11. The apparatus of claim 10, wherein the at least one point is not coincident with any one of said plurality of node points.

12. The apparatus of claim 9, wherein the memory is in a control centre.

13. The apparatus of claim 12, wherein the control centre includes communication means adapted to transmit data defining the positions of the commencement and termination points from the control centre to a plurality of vehicles equipped to measure the transit time between the commencement and termination points.

14. The apparatus of claim 13, wherein the communication means is adapted to receive data relating to the measured transit time from the vehicles.

15. The apparatus of claim 13, wherein the communication means is adapted to transmit data relating to the predicted transit time.

16. The apparatus of claim 9, wherein there is recorded in the memory a programme for defining the predicted transit time between the commencement and termination points, wherein the programme calculates a predicted transit time dependent on one or more of the location of the points, the monitored traffic conditions and the time of day.

17. A method of monitoring traffic comprising: selecting a commencement point and a termination point on a road network,
communicating positional data for the commencement point and termination point to each of a plurality of vehicles,
at each of the plurality of vehicles monitoring when the vehicle passes from the commencement point to the termination point and calculating the transit time taken for the vehicle to travel between the two points,
comparing the transit time taken with a standard transit time for travel between the two points, and
communicating with a control centre if said transit time taken exceeds the said standard transit time by more than a preset amount.

18. The method of claim 17, wherein the standard transit time and the preset amount are selected at the control centre and communicated to each of the plurality of vehicles.

19. The method of claim 17, wherein the standard transit time and the preset amount vary according to one or more of the location of the points, the monitored traffic conditions and the time of day.

20. An apparatus for monitoring traffic in a road network comprising a plurality of arrangements each carried by respective vehicles, each arrangement comprising calculating means for calculating the transit time taken to travel between two points and for comparing the transit time taken with a standard transit time for travel between the two points and communicating means communicating with a control centre if said transit time taken exceeds the said standard transit time by more than a preset amount, wherein said communicating means is adapted to receive information from the control centre defining the position on the road network of at least one of the two points.

21. The apparatus of claim 20, wherein the two points are a commencement point and a termination point respectively.

22. A method of monitoring traffic comprising:
establishing along a road first and second points at respective ends of a route segment along which a vehicle is to travel, the route segment being subdivided into a number of links,
at the vehicle, calculating in turn the transit times taken for the vehicle to travel along respective links of the route segment,
in turn comparing the transit times taken with expected transit times for the respective links, and
communicating with a control centre if and when any of the transit times taken exceeds the corresponding expected transit time by a predetermined threshold.

23. The method of claim 22, wherein each link extends from a commencement point to a termination point.

24. The method of claim 23, wherein the control centre transmits to the vehicle information defining the position of at least one of the said commencement point and termination point.

25. An apparatus for monitoring traffic comprising:
establishing means arranged to establish along a road first and second points at respective ends of a route segment along which a vehicle is to travel, the route segment being subdivided into a number of links, and
an arrangement to be carried by the vehicle and comprising calculating means which serves to calculate in turn the transit times taken for the vehicle to travel along the said links, comparing means which serves to compare in turn the transit times taken with expected transit times for the respective links, and communicating means which serve to communicate with a control centre if and when any of said transit times taken significantly exceeds to corresponding expected transit time.

26. The apparatus of claim 25, wherein each link extends from a commencement point to a termination point.

27. The apparatus of claim 26, wherein said communicating means is adapted to receive information from the control centre defining the position of at least one of the said commencement point and termination point.
